(19) United States
(12) Patent Application Publication
(10) Pub. No.: US 2024/0037657 A1
(43) Pub. Date: Feb. 1, 2024

(54) SYSTEM OF CRYPTOCURRENCY MINING USING NON-FUNGIBLE TOKENS

(71) Applicant: BMC Ventures Inc., San Juan Capistrano, CA (US)

(72) Inventors: Brandon L. Castaneda, Data Point, CA (US); Michael J. Jalonen, San Juan Capistrano, CA (US); Patrick D. Miller, San Marcos, CA (US)

(73) Assignee: BMC Ventures Inc., San Juan Capistrano, CA (US)

(21) Appl. No.: 18/165,839

(22) Filed: Feb. 7, 2023

Related U.S. Application Data
(60) Provisional application No. 63/393,889, filed on Jul. 30, 2022.

(51) Int. Cl. G06Q 40/04; G06Q 20/06; G06Q 20/36

(52) U.S. Cl. CPC G06Q 40/04; G06Q 20/065; G06Q 20/36

(57) ABSTRACT

A system of cryptocurrency mining comprising at least one cryptocurrency mining machine, a rewards pool for receiving cryptocurrency from the mining machine, and a non-fungible token configured to direct a fractionalized portion of the cryptocurrency in the rewards pool to an owner of the non-fungible token. The invention relates to fractionalizing rewards to non-fungible token holders, such as Bitcoin and other cryptocurrency mining. More broadly, the non-fungible token, methods, and systems disclosed herein can easily be employed by rewards pools and rewards pool managers of all kinds, as would be understood by one of ordinary skill in the art. By fractionalizing hard to apportion devices and systems, the inventions described herein can fine tune the cost of entry to profitable endeavors, proving new opportunities by democratizing ownership.

### STATEMENT OF PRIORITY

This application claims priority to U.S. Provisional Patent Application No. 63/393,889, dated Jul. 30, 2022 to Castaneda, et. al.

### BACKGROUND OF THE INVENTION

### 1. Technical Field

The invention disclosed herein relates to distributed ledger technology and cryptocurrency. In particular, the invention relates to using non-fungible tokens (“NFTs”) to facilitate distributing rewards to the owner(s) of the NFT(s), including by way of non-limiting example, Bitcoin mining and other cryptocurrency mining. The invention disclosed herein also relates to non-fungible tokens' use in managing and displaying contracts between one or more parties.

### 2. Related Art

This patent draws from and improves upon PCT Patent Application No. WO2020060606 and U.S. Patent Application Publication No. US20210399893A1. U.S. Pat. No. 11,045,730 is also referenced herein for completeness. All patents, patent applications, prior publications and websites referenced herein are incorporated in their entirety, as are the references that they cite.

Cryptocurrency mining can be the best and/or cheapest way to acquire cryptocurrency. As the difficulty increases, more sophisticated and expensive machines are needed to mine cryptocurrency. For example, at the time of filing this provisional application a good 100TH Bitcoin miner costs between $4,500 and $11,000 under various cryptocurrency market conditions. As a result, the cost of entry to mine Bitcoin is too high, and discouraging to potential users at the outset.

Bitcoin mining on ones's own requires maintenance of the miners, replacement of the miners with more efficient models, supplying energy to run and cool the miners, and management of the heat and noise coming from the machines. There can be downtime on one or more machines.

Continuing with the Bitcoin mining example, hosting companies exist that allow a group of users to “chip in” together in order to afford one Bitcoin miner. These companies can be referred to as cryptocurrency mining hosting companies, cryptocurrency mining pools, or cryptocurrency miner rental companies, but these too have drawbacks. F2pool.com is an example of one such company. Users of a Bitcoin miner hosting company do have the convenience of not needing to maintain their own machines. However, the value of a user's share in the mining pool is set by the hosting company. The hosting company might not allow a user to sell back its portion of the mining pool at all. The hosting company or the user must apportion the amount of cryptocurrency rewards a user receives and then transfer the mined and apportioned cryptocurrency to the user somehow. Digital wallet addresses must be stored and maintained for all users. This process costs fees, takes time, and limits the resale-ability of the user's purchased portion of the rewards pool. There is a lot of waste in this system of rewards fractionalization.

Joint ownership of an asset such as a rewards pool or a Bitcoin miner becomes more burdensome to manage the more owners there are. The benefits of fractionalization of an asset usually begin to be offset by the burden of logistics related to managing a growing number of owners, including overseeing increasing amounts of related data and transactions. Typically there comes a point in the fractionalization process where it no longer pays to divide the asset. It becomes too much of a hassle, too unprofitable, or both.

Finally, assets with a plurality of joint owners leave each owner owning just part of the asset. It is often harder to sell part ownership in something, creating illiquid markets for the owners to deal in, and leaving them with few options. Sometimes, an owner of part of an asset will be forced to hold on to an asset he or she does not want anymore or sell their portion for a much lower price.

Therefore, there is a need for a device and/or system capable of automatically and efficiently fractionalizing ownership of a rewards pool to a granular level. There is also a need for an efficient way to transfer ownership in joint assets.

### SUMMARY

Disclosed is an non-fungible token and system that automatically fractionalizes ownership in a rewards pool, said ownership being transferable. Importantly, as used herein the words “non-fungible token” and “NFT” are used interchangeably. “Distributed ledger” and “Blockchain” are also used loosely. These terms are meant to be used as broadly as possible as the disclosure teaches an invention for use with any distributed ledger technology, and not meant to limit to types of distributed ledgers, of which a subset are called a “Blockchain.” Finally, the terms “database”, “ledger”, “storage”, “store”, and other references to digitally stored information recognize that the present invention refers to data that can be stored digitally somehow, anywhere, without necessarily needing to be stored in the place we find in these examples.

Herein, the broader term always applies.

A system of rewards distribution is disclosed herein. Such a system may comprise a rewards generator, a rewards pool configured to store rewards from the rewards generator, a communication network, one or more online distributed ledgers, and a plurality of non-fungible tokens used to direct the rewards from the rewards pool to one or more owners of said non-fungible tokens.

In one embodiment, a task server can be configured to apportion the rewards belonging to the one or more owners and direct the rewards to the appropriate one or more owners. Preferably, the task server can automatically direct the apportionment of the rewards, automatically direct the transfer of the rewards, or both.

In fact, embodiments exist where the instruction module is a task server that can be directed, or controlled, by a decentralized autonomous organization, or DAO, consisting of some or all of the one or more owners. These owners, sometimes called “users” herein, or “holders” of the NFTs, can claim their rewards manually. For example, through Strike App. However, it can be preferable to automatically send the rewards to the owners without them needing to claim their portion manually.

Preferably, one or more databases can be used to store information relevant to the system of rewards distribution. By way of non-limiting example, one or more contracts may be used to govern the rewards distribution system. Information comprising how many rewards are to be sent, where to send the rewards, and the time in effect of the contract, are just a few of many examples of information that might be relevant to the transactions. As such, the database, distributed ledger, plurality of non-fungible tokens, or any combination thereof can be used to fractionalize the rewards for the purpose of apportioning the rewards and/or sending the correct amount of rewards to the correct owners.

In one embodiment the rewards generator is a cryptocurrency miner and digital wallets can be used to store the rewards. Non-fungible tokens can also be stored in digital wallets. Preferably, the plurality of non-fungible tokens are stored in digital wallets belonging to the owners and the portion of the rewards belonging to each owner can be directed straight to those wallets. An online marketplace can also be provided for trading the non-fungible tokens.

A system of rewards distribution comprising a cryptocurrency miner, for example a Bitcoin miner is also disclosed herein. In one cryptocurrency mining embodiment, a rewards pool can be configured to store cryptocurrency rewards from the cryptocurrency miner. A communication network is provided to provide interconnectivity between modules such as one or more online distributed ledgers, a database, a Blockchain, cryptocurrency system, and/or a plurality of non-fungible tokens configured to direct the cryptocurrency rewards from the rewards pool to one or more owners of said non-fungible tokens.

One of ordinary skill in the art, however, would recognize that any cryptocurrency miner can be used, including but not limited to Ethereum mining, Ethereum token mining, or other alternative cryptocurrency coin or token mining.

Finally, a user interface or online dashboard can be used as an effective means of displaying transactional information. Such a system might comprise a contract between two or more parties, said contract represented, sellable, and/or transferable using a non-fungible token. The terms and parameters governing the contract can be stored on-chain in a distributed ledger off-chain in one or more databases accessible by a communication system. In one embodiment, a user interface can be configured to access the distributed ledger, non-fungible token, database. or any combination thereof to display information relevant to the contract in a user friendly way. And again, an online marketplace can be provided to transfer one or more non-fungible tokens between owners, also called holders or users of the system.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

Everything presented in these figure is exemplary and not meant to exclude the many other embodiments apparent to one of ordinary skill in the art.

FIG. 1 is a simplified system block diagram of one implementation of a rewards distribution system in accordance with the present disclosure.

FIG. 2 is a system diagram of one example of a decentralized cryptocurrency system as presented by Abramson, et al. in WO 2020/060606 A1, FIG. 2, fully incorporated herein.

FIG. 3. is a flow diagram based on the simple block diagram of FIGS. 1 and 2, and depicting the distribution of rewards in accordance with one implementation of the disclosure.

FIG. 4 is a simple system diagram in accordance one implementation of the disclosure.

FIG. 5 is a depiction a user interface that can be used in accordance with the disclosure.

### DETAILED DESCRIPTION OF THE PREFERRED EMBODIMENTS

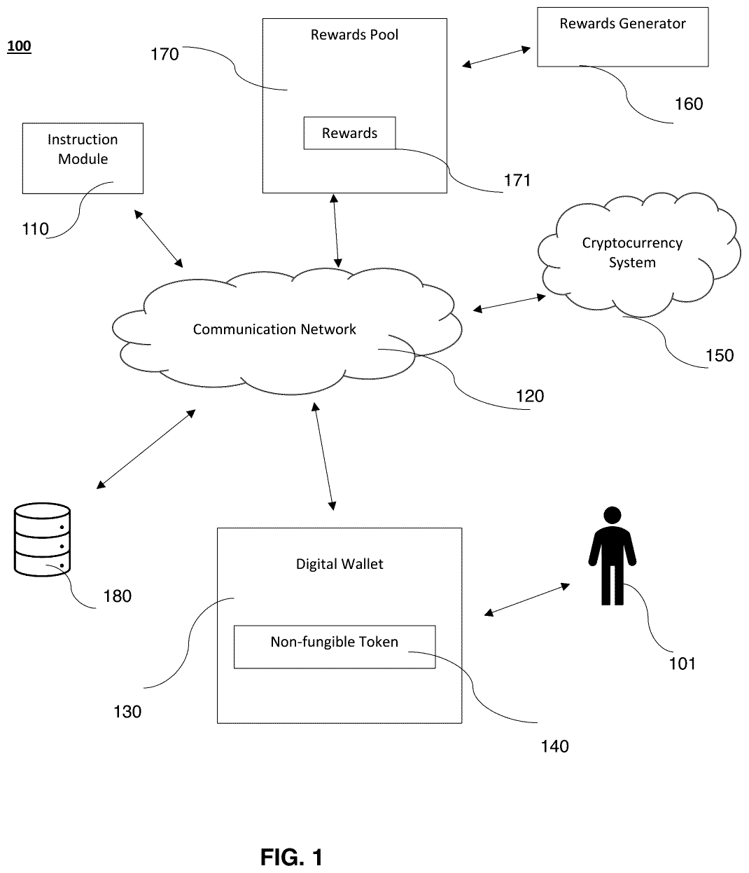

While the invention has been shown and described with reference to a particular embodiment or embodiments thereof, it will be understood to those skilled in the art that various changes in form and details may be made therein without departing from the spirit and scope of the invention. FIG. 1 illustrates one example of a rewards distribution system 100 with at least

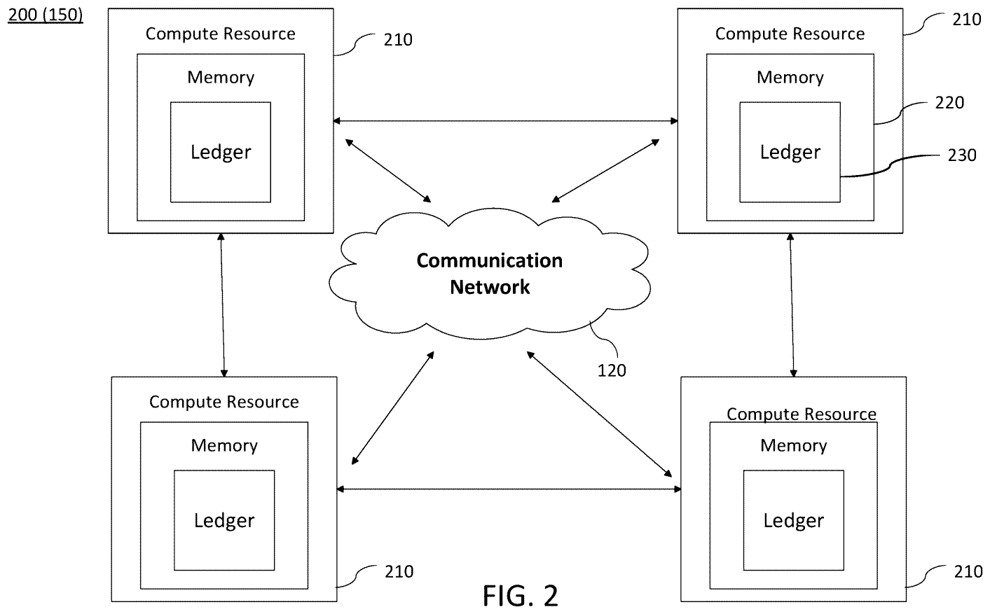

one non-fungible token 140 for directing rewards 171 from a rewards pool 170 to the holder 101, 130 of the non-fungible token 140. Cryptocurrency system 150 is any distributed ledger, including publicly accessible distributed ledgers such as depicted in FIG. 2 in more detail.

One preferred implementation of a rewards distribution system 100 in accordance with the present invention relates to Bitcoin mining. Bitcoin mining is presented in a 2008 published paper by Satoshi Nakamoto, entitled “Bitcoin: A Peer-to-peer Electronic Cash System”, and incorporated in its entirety herein. In such a system, machines called Bitcoin miners perform calculations for which they are awarded the digital currency Bitcoin. In this embodiment, rewards generator 160 is one or more Bitcoin mining machines and rewards 171 are the Bitcoin awarded for mining with the Bitcoin mining machines 160. The rewards 171 of the present invention can be split amongst one or more holders 101 (interchangeably called “owners” and “users” herein), of the related non-fungible token(s) 140. Rewards 171 are stored in rewards pool 170 prior to distribution. Rewards pool 170 can be a community digital wallet, bank account, or any other store of, in this example, the cryptocurrency Bitcoin.

In some embodiments, non-fungible token 140 is stored in digital wallet 130. Preferably digital wallet 130 and non-fungible token 140 belong to holder 101. However, one of ordinary skill in the art would understand that non-fungible token 140 need not be stored in digital wallet 130. Information related to non--fungible token 140 can be located anywhere, however. For example, database 180. To be clear, it is the private encryption/decryption keys that are stored in the digital wallet 130 while typically the NFT 140 is stored on the distributed ledger 150, Blockchain 200/150, and/or a third party decentralized (or centralized) database for storing information including any artwork related to the NFT 140 and/or related to displaying NFT 140. For example, IPFS can be used for storing digital artwork. However, any other information, such as information related to any utility associated with the NFT can also be stored in any of these locations. For example, terms, parameters, and conditions of a contract or transaction can be stored, holder 101 information can be stored, digital wallet 130 information can be stored, as can any number of other pieces of data relating to the components of system 100, 200, 300 or 430, as would be understood by one of skill in the art.

In general practice, The code for the non-fungible token 140 itself is located on cryptocurrency system 150, such as a blockchain 200 (150). Specifically, the related “smart contract” (also stored on the blockchain 200/150), is configured to be aware there are non-fungible, indivisible tokens 140, with specific ID numbers, owned by specific digital wallets 130 on the blockchain 200/150. The appearance of non-fungible token 140 can be elaborate or not; many prefer to store a work of digital art and represent the non-fungible token 140 with that art. In just one example, the artwork is stored on IPFS, a decentralized file hosting system. By way of non-limiting example, a non-fungible token 140 can be linked to the artwork by a specific functionality around baseURI +tokenURI creating a web link. Of course, one of ordinary skill in the art would recognize that the art can be stored anywhere, decentralized or not.

By way of non-limiting example database 180 can exist on or off the blockchain. In some embodiments, database 180 can store information sufficient to direct the appropriate rewards 171 to digital wallet 130 without the need for non-fungible token 140 to be located in digital wallet 130.

In other embodiments, it may be preferable for database 180 to contain additional information associated with the non-fungible token 140. By way of non-limiting example, it may be preferable for database 180 to store the lot number of one or more non-fungible token 140(s) in order to associate one or more attributes to each non-fungible token 140. For example, different non-fungible token 140s might be attributable to one or more shares of the rewards pool 170. If so, this information must be stored. One of ordinary skill in the art could envision any number of attributes it may be preferable to store. Addresses, names digital wallet addresses are all non limiting examples of data one can store in database 180. In fact, any data can be attributable to a non-fungible token 140; it might be preferable to store in database 180 entire contracts related to an non-fungible token 140. Software instructions to be executed if certain conditions are met can also be stored in database 180. One of ordinary skill in the art would recognize that a wide variety of data can be helpful to rewards distribution system 100.

Database 180 is also depicted in FIG. 1 as one database. However, one of ordinary skill in the art would understand that the information discussed herein could be in one database 180 as depicted, or spread out among many locations, one or more blockchains 200/150, or indeed any number and combinations of addressable memory would suffice. In addition, one of ordinary skill in the art would understand that oracles, feeds, calendars and/or any other source of relevant information can be used to provide data to the rewards distribution system 100, including database 180 and instruction module 110.

Instruction module 110 is connected to communication network 120 and may be used to query database 180, query cryptocurrency system 150, or any other element of rewards distribution system 100. In one preferred embodiment, instruction module 110 queries blockchain 200/150 and/or database 180 (database 180 can be on or off cryptocurrency system 150, meaning data can be stored in the distributed ledger 150′s ledger 230) to acquire data related to each non-fungible token 140 and/or holders 101 in rewards distribution system 100. Preferably instruction module 110 uses this data to facilitate the transfer of a portion of the rewards 171 from rewards pool 170 to the digital wallet 130 of the appropriate holder 101 of non-fungible token 140.

Queries, transfers, and other instructions and/or tasks can be performed by instruction module 110 related to any number of non-fungible tokens 140 and any number of holders 101 so that the rewards 171 from rewards pool 170 are fractionalized as minutely as desired to as many holders 101 as desired. Using non-fungible token 140, which can be created easily, digitally, at will or according to preset rules, allows an almost infinite degree of fractionalization. For holder 101, non-fungible token 140 can be paperless, easy to manage, easy to buy and sell and transfer, and as would be understood by one of ordinary skill in the art, also easy to further fractionalize.

Instruction module 110 can help facilitate and/or manage the functions of the system. In a preferred embodiment instruction module 110 is a task server. But as one of ordinary skill in the art would recognize, instruction module 110 can be anything capable of querying the system and instructing the system to perform transactions. Accordingly, instruction module 110 could even exist on the cryptocurrency system 150, using its resources (See FIG. 2). Instruction module 110 is preferably scripted to be automated, but can be performed in any manner including by a managing entity which can be a form of artificial intelligence, a managing company, or even a human using non-fungible token 140 and its related data by hand. Importantly, the holders 101 being able to manually or automatically claim their rewards 171 is also within the scope of the invention when non-fungible token 140 ownership is used to apportion the rewards. For example, holders 101 can claim rewards to their own digital wallets 130 using a standard claim process or through a third party application such as Jack Maller' s Strike app, incorporated herein by reference. A check can be performed to determine the ownership of non-fungible tokens 140 before making any transfers.

Communication network 120 may include any wired or wireless connection, the internet, or any other form of communication. Although one network 120 is identified in FIG. 1, communication network 120 may include any number of different communication networks between any of the servers, devices, resources and systems shown in the FIGs,. and/or other servers, devices, resources and systems described herein. Communication network 120 may enable communication between various computing resources or devices, servers, and systems. Various implementations of communication network 120 may employ different types of networks, for example, but not limited to, computer networks, telecommunications networks (e.g., cellular), mobile wireless data networks, and any combination of these and/or other networks.

Cryptocurrency system 150 may include one or more processors for processing commands and one or more memories storing information in one or more cryptocurrency data structures. In some embodiments, cryptocurrency system 150 may be a centralized cryptocurrency system or network, for example, but not limited to, a server which may be privately run by a third party entity or the same entity that is running the instruction module 110. In other embodiments, cryptocurrency system 150 may be a publicly accessible network system (e.g., a distributed decentralized computing system).

For example, cryptocurrency system 150 may be a decentralized network 200, such as a decentralized blockchain network, including one or more compute resources 210, as shown, for example, in FIG. 2. In the embodiment of FIG. 2, there may be no central authority controlling cryptocurrency network 200. The data stored on blockchain network 200, i.e., the public ledger, may not be stored at a central location in its entirety. Blockchain network 200 may include a plurality of processors for processing commands and a plurality of memories storing information in one or more blockchain data structures. Blockchain network 200 may maintain one or more blockchains of continuously growing lists of data blocks, where each data block refers to previous blocks on its list. The requirement for each block to refer to all previous blocks in the blockchain, yields a chain of blocks that is hardened against tampering and revision, such that the information stored in the blockchain is immutable.

Compute resources 210 may include any device, computer, system or otherwise that has joined blockchain network 200 and forms a node in blockchain network 200. Compute resources 210 may include, for example, but not limited to, personal computers, servers, cell phones, tablets, laptops, smart devices (e.g. smart watches or smart televisions), or any other device capable of storing information and communicating over communication network 120. In some embodiments, compute resources 210 may be unaffiliated with or unknown to each other where, for example, compute resources 210 remain anonymous. Each compute resource 210 may include memory 220 that stores a copy of at least a portion of public ledger 230 of blockchain network 200. Compute resources 210 may also execute one or more programs to perform various functions associated with maintaining blockchain network 200 including, for example, updating public ledger 230, generating new blocks, or any other similar function.

For illustration purposes, FIG. 1 illustrates digital wallet 130, database 180, non-fungible token 140, instruction module 110, rewards generator 160, and rewards pool 170 as not included in blockchain network 200. However, any or all of digital wallet 130, database 180, non-fungible token 140, instruction module 110, rewards generator 160, and rewards pool 170 can be part of blockchain network 200 and be implemented as one of the compute resources 210 in FIG. 2.

Public ledger 230 may store any transactions performed over blockchain network 200 including but not limited to, for example, any transaction related to and occurring on blockchain network 200. Because each compute resource 210 stores a copy of at least a portion of the public ledger 230 of blockchain network 200, public ledger 230 may be independently verified for accuracy at any time by comparing the stored copies of multiple compute resources 210.

Communication between compute resources 210 may occur via communication network 120. Communication network 120 of FIG. 2 may be the same network as, or be a different network from, communication 120 of FIG. 1. In some embodiments, each compute resource 210 may communicate directly with each other compute resource 210. In some embodiments, some compute resources 210 may not be able to communicate directly with each other. For example, they are not connected to the same communications network 120. In this case, communications related to blockchain network 200 between the compute resources 210 may occur by using one or more of the remaining compute resources 210 as an intermediary. In some embodiments, one or more of compute resources 210 may not maintain a continuous connection to blockchain network 200 at all times. For example, a compute resource 210 may only be connected to blockchain network 200 during a certain period of time each day or may only be connected to blockchain network 200 intermittently throughout the day. Due to the decentralized nature of blockchain network 200, such an intermittent connection by one or more compute resources 210 does not affect the overall operation of blockchain network 200 since copies of public ledger 230 are stored on multiple compute resources 210. Once the disconnected compute resource 210 reconnects to blockchain network 200, the disconnected compute resource 210 may receive updated copies of the public ledger 210 from one or more of the compute resources 210 that have been connected to blockchain network 200.

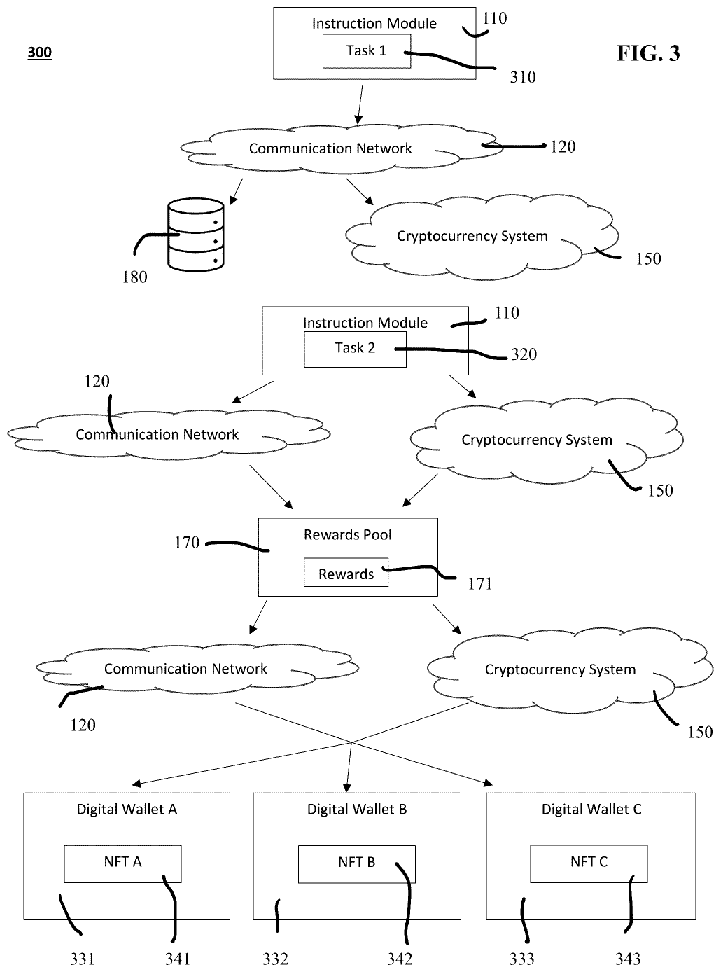

Turning now to FIG. 3, we present a flow diagram depicting a preferred embodiment where instruction module 110 directs an implementation of the invention. In this figure, three (3) digital wallets 331, 332, 333 will each receive a portion of the rewards 171 in rewards pool 170. However, the invention disclosed herein is capable of directing rewards 171 to any number of digital wallets 130. Workflow does not need to happen in the specific order depicted to fall within the scope of the invention disclosed herein. FIG. 3 simply depicts one example of the system in action.

In this implementation of rewards distribution system 100 uses non-fungible tokens A, B, and C 341, 342, 343 to locate and send rewards 171 from rewards pool 170 to digital wallets A, B, and C 331, 332, 333 by a combination of one or more of instruction module 110, communication network 120, cryptocurrency system 150, and database 180.

In this depiction instruction module 110 executes Task 1 310. Preferably, instruction module 110 is automated, however it may be programmed and/or controlled by way of non-limiting example, a managing company, person, or DAO. In one embodiment, Task 1 310 is a query to determine where to send the rewards 171. Preferably, a blockchain 200 querying platform or script can be used to get a comprehensive list of who has what non-fungible tokens 441, 442, 443 and possible other information including number of shares or any number of pieces of information related to the who, what, where, when, and how of the transaction(s). This information can be located, by way of non-limiting example, on the blockchain;cryptocurrency system 200 (150) or off-chain in one or more databases 180.

Once the necessary information for the transaction is received by the instruction module 110, instruction module 110 can then execute Task 2 320. In one implementation of FIG. 3, Task 2 320 can be an instruction to send a portion of the rewards 171 to the appropriate digital wallet 130. One of ordinary skill in the art would also recognize that it may be desirable for other intermediary tasks to take place before Task 2 320 is executed. Likewise, one of ordinary skill in the art would also recognize that it may be preferable for additional steps or tasks to take place after execution of Task 2 320. In certain embodiments, it may make sense to perform recording and/or reporting of information related to the transferring of rewards 171 by Task 2 320.

By way of non-limiting example, instruction module 110 can use the data obtained from the query of Task 1 310 to distribute rewards 171. In the illustration of FIG. 3, instruction module 110 will use the query obtain and/or store the information it will need to send the appropriate portions of rewards 171 to digital wallets A, B, and C 331, 332, 333 associated with non-fungible tokens A, B, and C 341, 341, 343, respectively. This information can include the token ID numbers, the portion of the rewards 171 attributable each non-fungible token A, B, and C 341, 341, 343, and the addresses of the digital wallets A, B, and C 331, 332, 333 associates with each non-fungible token A, B, and C 341, 341, 343. One of ordinary skill in the art would recognize other types of information related to the system may be desirable to query and store. With the data received by the query, the rewards 171 in rewards pool 170 can be fractionalized and apportioned to any number of holders 101. In this example, this happens via Task 2 320.

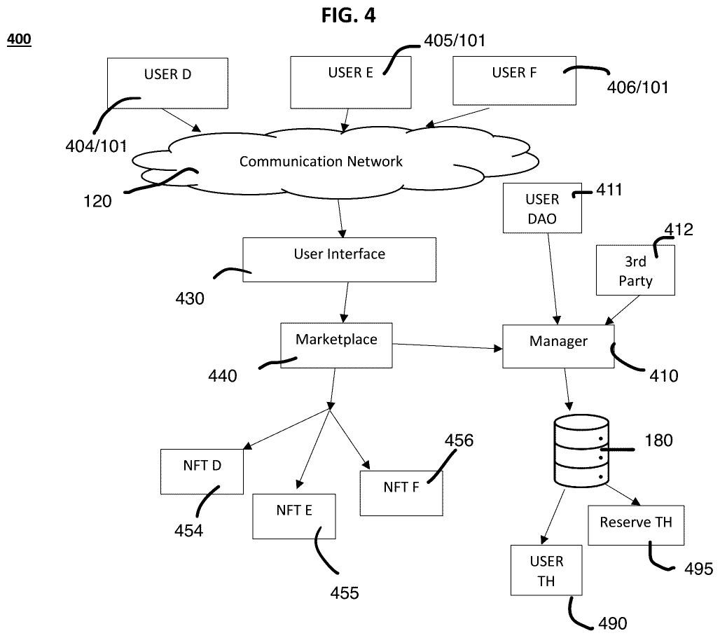

FIG. 4 depicts a marketplace embodiment 400 of the disclosed invention wherein a user interface 430 and/or marketplace 440 can be used to access and manage non-fungible tokens 454, 455, 456. By way of non-limiting example, non-fungible tokens 454, 455, 456 can incorporate, reference, or otherwise facilitate the execution of a contract between a manager 410 and users D, E, and F 404, 405, 406, respectively. In this example, rewards generator 160 is a Bitcoin miner with 100 TH/s and manager 410 is tasked with collecting, apportioning, and transferring Bitcoin rewards 171 from rewards wallet 170 to Users D, E, and F 404, 405, 406.

Users D, E, and F, 404, 405, 406 might use communication network 120 to access a user interface 430 and/or online marketplace 440. Preferably, marketplace 440 is configured to allow users D, E, and/or F 404, 405, 406 the ability to purchase non-fungible tokens D, E, and F, 454, 455, 456, respectively. Of course, one of ordinary skill in the art would understand the disclosed invention facilitates fractionalization of Bitcoin miner 160's 100 TH/s to any number of users and non-fungible tokens. The depiction of three (3) users 404, 405, 406 and three (3) non-fungible tokens 454, 455, 456 is meant to illustrate a plurality and not meant to limit the disclosed system to three (3) users 404, 405, 406 or just three (3) non-fungible tokens 454, 455, 456.

Continuing with this example, non-fungible token 454 could represent the terms of a contract for Bitcoin mining. Non-fungible token 454 might be configured to offer User D 404 the portion of Bitcoin rewards 171 attributable to 1 TH/s of the 100 TH/s Bitcoin miner 160. Non-fungible token 455 might be configured to offer user E 405 the portion of Bitcoin rewards 171 attributable to 20 TH/s of the 100 TH/s Bitcoin miner 160.

Meanwhile, non-fungible token 456 might be configured to offer user F 406 the portion of the Bitcoin rewards 171 attributable to 50 TH/s of the 100 TH/s Bitcoin miner 160. In this example, 29 TH/s of the 100 TH/s Bitcoin miner 160 remains unused after users D, E, and F 404, 405, 406 purchased non-fungible tokens D, E, and F 454, 455, 456 from marketplace 440. It may be preferable to limit the length of the contract to, for example, six (6) months.

However, one of ordinary skill in the art could determine a contract length of less than six (6) months might be preferable. Similarly, one of ordinary skill in the art could determine a contract length of more than six (6) months might be preferable.

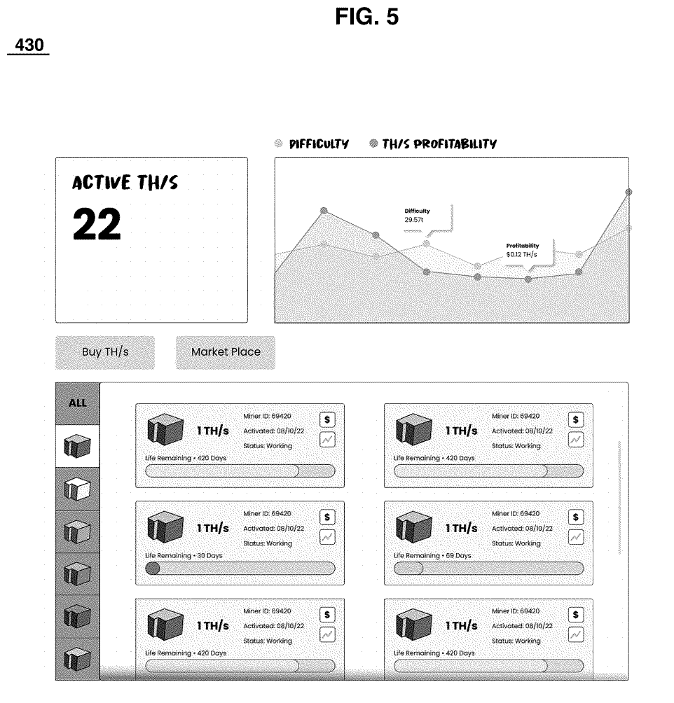

FIG. 5 is an illustration of a sample user interface 430 in conjunction with the present invention. Said user interface 430 can include a link to a marketplace as well as a dashboard containing all relevant information related to the system of distributing rewards 100 and for displaying the non-fungible tokens 140, 454, 455, 456 in a manner where the terms of any contracts or transactions related to the non fungible tokens 140, 454, 455, 456 can be seen, understood, and managed by users 101, 404, 405, 406, instruction module/manager 110, 410, DAO 411, and/or 3^{rd} Party Company 412.

FIG. 4 also depicts a database 480/180 configured to store information needed to manage the total TH/s of the marketplace system 400. If maintaining the current, non-limiting example of a single 100 TH/s Bitcoin miner whose TH/s is fractionalized and apportioned to the users D, E, and F 404, 405, 406 with 29 TH/s left over unused, then database 480/180 can be configured to maintain files and separate the 81 used TH/s in the used TH storage 490 from the 29 unused TH/s in unused TH storage 495. Preferably, TH/s is reserved in the reserved TH storage 495 for use in the event that a portion or all of the active TH/s in the used TH/s storage 490 becomes compromised in anyway. Reserved TH storage 495 can represent the unused and/or unsold portion of Bitcoin miner 160's TH/s. The rewards 171 from this unused portion of the Bitcoin miner 160 might preferably go to users D, E, and/or F 404, 405, 406, manager 410, and/or any other entity. The reserved TH storage 495 can also be preferably used for additional TH/s purchases on marketplace 410, said purchases might preferably take the form of additional non-fungible token(s) 140 purchases.

Instruction module 110 can be a Manager 410 is preferably configured to maintain and store all necessary information relating to users D, E, and F 404, 405, 405, their purchases of non-fungible tokens D, E, and F 454, 455, 456, and any information necessary to execute the contract implied by non-fungible tokens D, E, and F 454, 455, 456. For example, manager 410 might store information related to where to send the appropriate amount of rewards 171 for each user 404, 405, 406. Manager 410 might use database 480 to store all the related information. However one of ordinary skill in the art would recognize that database 480 could be the same as database 180, a different database, or a plurality of databases or storage locations, including on the blockchain 200/150.

Manager 410 can be a 3^{rd} party 412 such as a company , a person, a decentralized set of instructions, or any entity. One or ordinary skill would also recognize that any one or more of user(s) D, E, and/or F can also be the manager 410 of marketplace system 400. In addition, one of ordinary skill would recognize that a set of all users D, E, F 404, 405, 406 could include all additional users 101 contemplated but not depicted in FIG. 4. This set of all users could form a decentralized autonomous organization (or “DAO”) 411.

DAO 411 can be defined to include all holders 101 of the non-fungible tokens 140 in system 100 (or 400). DAO 411 can be set up to provide all users 101 of non-fungible tokens 140 with voting rights and thus the ability to manage the system in some capacity. In FIG. 4, DAO 411 might comprise user D 404, user E 405, and user F 406. In some preferred embodiments, DAO 411 acts as manager 410 and directs elements of marketplace system 400. In this example, DAO 411 can obviate the need for a 3^{rd} party 412 manager 410. However, one of ordinary skill would understand DAO 411 might prefer to still employ a 3^{rd} party 412 to manage all or a portion of marketplace system 400.

While various embodiments of the invention have been described, it will be apparent to those of ordinary skill in the art that many more embodiments and implementations are possible within the scope of the invention. The various embodiments described herein include a variety of cryptocurrency, distributed ledger technologies, smart contracts, and methods and systems for distributing rewards of all forms to a user by way of a token associated with its owner. The described example configurations of elements and methods are examples that may be embodied through equivalent configurations having additional or fewer of the described elements, systems, devices, and methods within the scope of the invention. Accordingly, the invention is not to be restricted except in light of the attached claims and their equivalents.

We claim:

1. A system of rewards distribution comprising:
a cryptocurrency miner,
a rewards pool configured to store cryptocurrency rewards from the cryptocurrency miner,
a communication network,
one or more online distributed ledgers, and
a plurality of non-fungible tokens for directing the cryptocurrency rewards from the rewards pool to one or more owners of said plurality of non-fungible tokens.

2. The system of claim 1 wherein the cryptocurrency miner is a Bitcoin miner.

3. The system of claim 1 wherein the cryptocurrency is an Ethereum miner.

4. The system of claim 1, further comprising a marketplace for trading the non-fungible tokens.

5. The system of claim 1, further comprising a plurality of digital wallets associated with each of the plurality of non-fungible tokens.

6. The system of claim 5, further compromising a database configured to store information related to the system.

7. The system of claim 5, further comprising a task server configured to carry out instructions for transferring the cryptocurrency rewards.
